(19) United States
(12) Patent Application Publication
(10) Pub. No.: US 2007/0057621 A1
(43) Pub. Date: Mar. 15, 2007

(54) Electron emission type backlight unit, flat panel display device having the same, and method of driving the flat electron emission unit

(76) Inventors: Young-Suk Cho, Suwon-si (KR); Yong-Soo Shoi, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/489,529

(22) Filed: Jul. 20, 2006

(30) Foreign Application Priority Data
Jul. 21, 2005 (KR) 10-2005-0066384

(51) Int. Cl. H01J 63/04; H01J 1/62

(52) U.S. Cl. 313/496

(57) ABSTRACT

An electron emission type backlight unit may include a front substrate, a rear substrate facing the front substrate with a predetermined distance therebetween, an anode and a fluorescent layer disposed behind the front substrate, first electrodes and second electrodes disposed on the rear substrate, the first electrodes and the second electrodes being spaced apart from each other, and electron emitting layers at least partially covering sides of at least one of the first electrodes and the second electrodes that extend along a direction other than a direction substantially or exactly parallel to the front substrate.

### BACKGROUND OF THE INVENTION

1. Field of the Invention

The invention relates to an electron emission unit and a flat panel display device having the same as a backlight. More particularly, the invention relates to an electron emission unit, which can reduce an anode field effect, and improve electron emission efficiency from second electrodes, and a flat panel display device including such an electron emission type backlight unit.

2. Description of the Related Art

Flat panel display devices may be classified as emitting display devices and non-emitting display devices. Examples of the emitting display devices include cathode ray tubes (CRTs), plasma display panel (PDPs), and field emission displays (FEDs). Examples of non-emitting displays devices include liquid crystal displays (LCDs).

In comparison to CRTs, PDPs, and FEDs, LCDs may be advantageous because LCDs may consume relatively less power during operation and may enable light-weight display devices. However, LCDs may employ external light to display images, i.e., produce images using received light, and thus, such LCDs may not display images in dark environments. Some LCDs employ a backlight unit, arranged at a back side of the LCD, to emit light. With such backlight units, LCDs may be used in dark environments.

Edge-type backlight units are known to be used as a linear light source and/or a point light source. For example, cold cathode fluorescent lamps (CCFLs), having electrodes at both ends of a tube, may be used as linear light sources, and light emitting diodes (LEDs) may be used as point light sources.

CCFLs may be advantageous in generating strong white light, providing superior brightness and uniformity, and relatively simple large scale design. However, CCFLs generally operate using high frequency alternating current, and generally have a narrow operating temperature range.

LEDs are generally inferior to CCFLs in brightness and uniformity. LEDs are generally advantageous relative to CCFLs because LEDs may operate with direct current (DC current), may have longer operating lives, may provide better power temperature characteristics, and may be relatively smaller in size.

Known edge-type backlight units may be disadvantages in that they may be structurally complex, may be high in cost and may consume a high amount of power when reflecting and transmitting light from a light source located on a side of the unit. In larger LCDs, uniform brightness may be hard to obtain with such edge-type backlight units.

Electron emission type backlight units with a planar light emitting structure have been proposed to solve the above problems. In comparison to CCFLs, such electron emission type backlight units may have low power consumption and relatively uniform brightness, even in a wide light emitting region.

A conventional electron emission type backlight unit may include a front substrate and a rear substrate, which are separated from each other by a predetermined gap. An anode and a fluorescent layer may be sequentially stacked on a bottom surface of the front substrate, and first electrodes are disposed on a top surface of the rear substrate. Stripe-patterned electron emitting layers may be disposed on the first electrodes. A high voltage for emitting electrons may be directly applied between the anode and the first electrodes, often causing local bending. Due to such local bending, the known electron emission type backlight unit cannot ensure uniform brightness over the entire surface. The local bending may also damage the anode, the first electrodes, the fluorescent layer, and the electron emitting layers, thereby shortening the life of the electron emission type backlight unit.

The conventional electron emission type backlight units may have a front substrate and a rear substrate, which are separated from each other by a predetermined gap. An anode and a fluorescent layer may be sequentially stacked on a bottom surface of the front substrate. Stripe-patterned first and second electrodes may be alternately disposed in parallel on a top surface of the rear substrate. Electron emitting layers may cover the first and second electrodes. While such a structure may reduce or prevent local bending, an anode field, generated by the anode, may affect an electric field formed between the first and second electrodes, thereby making it difficult to control electron emission from the second electrodes. The anode field may also cause undesirable diode radiation.

### SUMMARY OF THE INVENTION

The present invention is therefore directed to electron emission units and flat panel displays employing electron emission units, which substantially overcome one or more of the problems due to the limitations and advantages of the related art.

It is therefore a feature of an embodiment of the invention to provide an electron emission unit that can effectively block an anode field.

It is therefore another feature of an embodiment of the invention to provide an electron emission unit that can improve efficiency of electron emission from second electrodes.

It is therefore yet another feature of an embodiment of the invention to provide an electron emission unit having improved structures of electron emitting layers for reducing anode field effects and improve electron emission efficiency, and a flat panel display device having the electron emission unit.

It is therefore still another feature of an embodiment of the invention to provide an electron emission type backlight unit that can reduce unnecessary electron emission and power consumption by alternately arranging first and second electrodes, and alternately applying voltages to the first and second electrodes and which can also extend life span by preventing the degradation of a fluorescent layer, and a flat panel display device having such an electron emission type backlight unit.

It is therefore further another feature of an embodiment of the invention to provide an electron emission type backlight unit that can reduce costs incurred due to electron emitting layers by removing portions of the electron emission layers that do not contribute to electron emission, and a flat panel display device having such an electron emission type backlight unit.

At least one of the above and other features and advantages of the present invention may be realized by providing an electron emission type backlight unit, including a front substrate, a rear substrate facing the front substrate with a predetermined distance therebetween, an anode and a fluorescent layer disposed behind the front substrate, first electrodes and second electrodes disposed on the rear substrate, the first electrodes and the second electrodes being spaced apart from each other, and electron emitting layers at least partially covering sides of at least one of the first electrodes and the second electrodes that extend along a direction other than a direction substantially or exactly parallel to the front substrate.

The first electrodes and the second electrodes may have substantially a same shape. The first electrodes and the second electrodes may be alternately arranged in parallel on a top surface of the rear substrate facing the front substrate. The first electrodes and the second electrodes may form a striped pattem. The first electrodes and the second electrodes may have a same or substantially same height as measured from a flat surface of the rear substrate. The electron emitting layers may cover opposing side surfaces of at least one of the first electrodes and the second electrodes.

The electron emitting layers may have a same or substantially same height as the electrodes covered by the electron emitting layers as measured from a flat surface of the rear substrate. The electron emission type backlight unit may include auxiliary electrodes disposed on at least one of the first electrodes and the second electrodes to limit an anode field effect. An end portion of the respective one of the electron emitting layers closer to the front substrate may be further from the front substrate than an end portion of the electrode covered by the respective electron emitting layer to limit an anode field effect. The electron emitting layers may be spaced apart from a flat surface of the rear substrate facing the front substrate by a predetermined distance.

The insulating layers disposed between the rear substrate and the electron emitting layers, covering portions of the first electrodes and the second electrodes extending along the predetermined distance defined by the space between the flat surface of the rear substrate and the respective one of the electron emitting layers. The electron emitting layers may include a carbon nanotube.

At least one of the above and other features and advantages of the present invention may be separately realized by providing a flat panel display device including an electron emission type backlight unit including a front substrate and a rear substrate facing each other with a predetermined distance therebetween, an anode and a fluorescent layer disposed between the front substrate and the rear substrate, first electrodes and second electrodes disposed between the front substrate and the rear substrate to be spaced apart from each other, and electron emitting layers at least partially covering sides of at least one of the first electrodes and the second electrodes that extend along a direction other than a direction substantially or exactly parallel to the front substrate, and a light receiving device that is disposed in front of the electron emission type backlight unit and controls light provided by the electron emission type backlight unit to produce an image.

The anode and the fluorescent layer may be sequentially stacked on a bottom surface of the front substrate facing the rear substrate. The electron emitting layers may have a same or substantially same height as the electrodes covered by the electron emitting layers as measured from a flat surface of the rear substrate. The flat panel display device may include auxiliary electrodes disposed on at least one of the first electrodes and the second electrodes to block an anode field. The electron emitting layers may be extend a shorter distance from a flat surface of the rear substrate than the electrodes covered by the electron emitting layers, thereby reducing an anode field effect. The light receiving device may be a liquid crystal display device.

At least one of the above and other features and advantages of the present invention may be separately realized by providing a method of driving a flat panel display device including an electron emission type backlight unit including a front substrate and a rear substrate facing each other with a predetermined distance therebetween, an anode and a fluorescent layer disposed between the front substrate and the rear substrate, first electrodes and second electrodes disposed between the front substrate and the rear substrate to be spaced apart from each other, and electron emitting layers covering opposing surfaces between the first electrodes and the second electrodes, and a light receiving device that is disposed in front of the electron emission type backlight unit and controls light provided by the electron emission type backlight unit in order to produce an image, the method may include repeatedly applying a higher voltage to the first electrodes and a lower voltage to the second electrodes for a first period of time and, alternately, applying a lower voltage to the first electrodes and a higher voltage to the second electrodes for a second period of time such that electrons are alternately emitted from the electron emitting layers covering the first electrodes and the electron emitting layers covering the second electrodes. A voltage higher than the voltages applied to the first electrodes and the second electrodes may be applied to the anode.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a cross-sectional view of an electron emission type backlight unit according to an embodiment of the present invention;

FIG. 2 illustrates a partial, enlarged cross-sectional view of the electron emission type backlight unit illustrated in FIG. 1;

FIG. 3 illustrates a partial, enlarged cross-sectional view of an electron emission type backlight unit according to another embodiment of the present invention;

FIG. 4 illustrates a partial, enlarged cross-sectional view of an electron emission type backlight unit according to another embodiment of the present invention;

FIG. 5 illustrates a partial, enlarged cross-sectional view of an electron emission type backlight unit according to another embodiment of the present invention;

FIG. 6 illustrates a waveform diagram associated with a method of driving an electron emission type backlight unit according to an embodiment of the present invention;

FIG. 7 illustrates an exploded perspective view of a liquid crystal display (LCD) device and a backlight unit according to an embodiment of the present invention; and

FIG. 8 illustrates a partial cross-sectional view of the LCD device and the backlight unit illustrated in FIG. 7, along line VIII-VIII of FIG. 7.

### DETAILED DESCRIPTION OF THE INVENTION

Korean Patent Application No. 10-2005-0066384, filed on Jul. 21, 2005, in the Korean Intellectual Property Office, and entitled: “Electron Emission Type Backlight Unit, Flat Panel Display Device Having the Same, and Method of Driving the Flat Panel Display Device,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

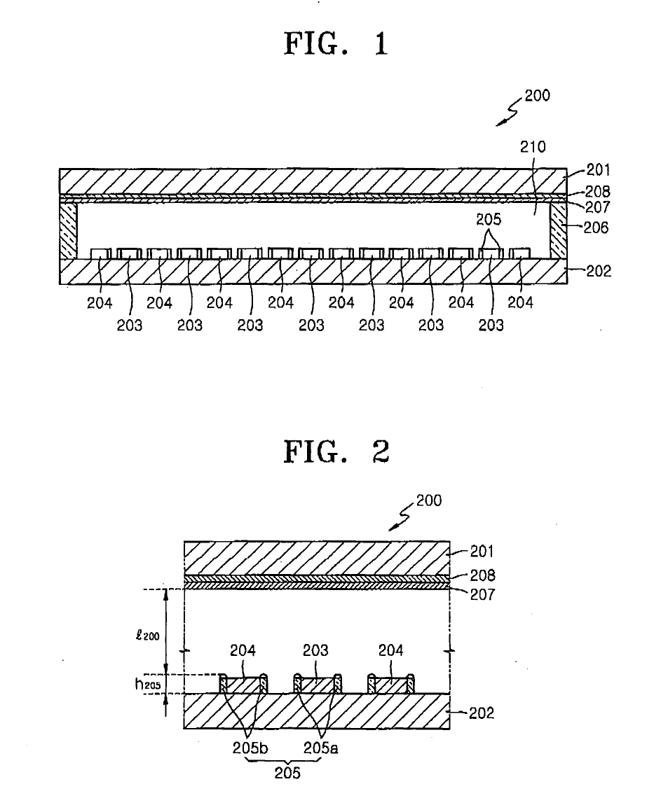

FIG. 1 illustrates a cross-sectional view of an electron emission type backlight unit according to an embodiment of the present invention. FIG. 2 illustrates a partial, enlarged cross-sectional view of the electron emission type backlight unit of FIG. 1.

Referring to FIGS. 1 and 2, a backlight unit 200 may include a front substrate 201 and a rear substrate 202. The front substrate 201 and the rear substrate 202 may face each other, and may have a predetermined distance therebetween.

An anode 207 and a fluorescent layer 208 may be disposed on a bottom surface of the front substrate 201 facing the rear substrate 202. The fluorescent layer 208 may be disposed on the bottom surface of the front substrate 201 facing the rear substrate 202. The anode 207 may cover the fluorescent layer 208. The fluorescent layer 208 may be excited with electrons to emit visible light. The anode 207 may be formed of a metal thin film and may receive an external high voltage for accelerating electron beams. In an exemplary operation, a specified external voltage, below a withstand voltage, may be applied to the anode 207 in order to accelerate electron beams and increase the brightness of the backlight unit 200.

In embodiments of the invention, the anode 207 may be, e.g., a transparent electrode formed of transparent conductive material, e.g., indium tin oxide (ITO), on a surface of the fluorescent layer 208. The anode 207 may receive a voltage for electron beam acceleration. Such a transparent anode 207 may cover the entire surface of the front substrate 201 or, e.g., may be patterned in stripes.

In embodiments of the invention, the anode 207 may include a transparent portion and a metal thin film portion. In other embodiments of the invention, the anode 207 may only include the transparent material or the thin metal film.

While the fluorescent layer 208 may be disposed between the anode 207 and the front substrate 201, the invention is not limited thereto. In embodiments of the invention, the order of stacking the fluorescent layer 208 and the anode 207 may be changed. For example, in contrast to FIG. 2, the anode 207 may be disposed on the bottom surface of the front substrate 201 facing the rear substrate 202, and the fluorescent layer 208 may cover the anode 207.

Referring to FIG. 1, an inner space 210 may be formed between the front substrate 201 and the rear substrate 202. In embodiments of the invention, the inner space 210 may be maintained at a pressure of about 10⁻⁶ Torr or less. Unless the inner space 210 is maintained in a high vacuum state, particles existing between the front substrate 201 and the rear substrate 202, and electrons emitted from electron emitting layers 205, may collide with each other and generate ions. Such collisions may cause ion sputtering and may deteriorate the fluorescent layer 208. Such residual particles may also collide with electrons accelerated by the anode 207, thereby causing the electrons accelerated by the anode 207 to lose energy. Thus, the electrons accelerated by the anode 207 may lose their energy and may not transmit sufficient energy when colliding with the fluorescent layer 208, and luminous efficiency may be decreased.

To improve luminous efficiency, the inner space 210 between the front substrate 201 and the rear substrate 202 may be hermetically sealed in the high vacuum state using a sealing member, e.g., glass frit. Laminated ends of the front substrate 201 and the rear substrate 202 may be sealed to form a sealed part 206.

The structure of an exemplary embodiment of the backlight unit 200, will be explained in detail below. The rear substrate 202 may be prepared and formed of, e.g., glass or similar material. As shown in FIG. 2, first electrodes 203 may be formed of, e.g., one or more of Cr, Nb, Mo, W, and Al. The electrodes 204 may be patterned in stripes on the rear substrate 202. Embodiments of the invention are not limited to such materials, and the first electrodes 203 may be formed of various materials and in various shapes, e.g., curves and polygons, so long as the first electrodes 203 can efficiently and uniformly supply electrons.

A plurality of second electrodes 204 may be formed of a transparent conductive material, e.g., ITO, IZO, or IN₂O₃, or a metallic material, e.g., Mo, Ni, Ti, Cr, W, or Ag. The second electrodes 24 may be patterned in stripes on the rear substrate 202 so that the first and second electrodes 203 and 204 may be alternately arranged on the rear substrate 202. Embodiments of the invention are not limited to such a structure. The second electrodes 204 may be formed of various materials and in various shapes, e.g., curves and polygons. The first electrodes 203 and the second electrodes 204 may have a same, or substantially same, height, as measured from a surface of the rear substrate 202 that faces the front substrate 201.

The electron emitting layers 205, i.e., electron emitting layers 205a, 20b, may cover electrodes, e.g., the first electrodes 203 and/or the second electrodes 204. The electron emitting layers 205 may only cover opposing or facing side surfaces of adjacent electrodes, e.g., opposing surfaces of adjacent first electrodes 203 and second electrodes 204. The electron emitting layers 205 do not cover sides of electrodes, e.g., outermost ones of the electrodes, which do not oppose other electrodes. The electron emitting layers 205 may cover opposing side surfaces of the first electrodes 203 and the second electrodes 204 because electron emission mainly occurs at the opposing side surfaces between the first electrodes 203 and the second electrodes 204. In embodiments of the invention, the electron emitting layers 205 may cover one, some or all of surfaces of one, some or all the first electrodes and/or second electrodes 203, 204 that extend along a direction other than a direction parallel to an upper surface of the respective electrode, which is closest to the anode 207.

Generally, little or no electron emission occurs at upper ends of the first electrodes 203 and the second electrodes 204. Thus, the electron emitting layers 205 may not be provided over the upper ends of the first electrodes and the second electrodes 204, which generally do not contribute to electron emission. The electron emitting layers 205 may only be provided on opposing side surface of the first electrodes 203 and the second electrodes 204. In embodiments of the invention, to reduce costs due to the electron emitting layers 205, the electron emitting layers 205 may not be provided over the upper ends of the first electrodes 203 and the second electrodes 204.

The electron emitting layers 205 may have a same or a substantially same height h₂₀₅ as the first electrodes 203 and the second electrodes 204 measured from a flat surface of the rear substrate 202 that faces the front substrate 201. In the exemplary embodiment illustrated in FIG. 2, the electron emitting layers 205 are shown to be slightly taller than the first electrodes 203 and the second electrodes 204 considering a process margin. The electron emitting layers 205 may be formed of, e.g., a carbon-based material having a low work function, e.g., carbon nanotube (CNT), graphite, diamond, diamond-like carbon (DLC), or fullerene (C₆₀). The electron emitting layers 205 may be formed by, e.g., chemical vapour deposition (CVD), physical vapor deposition (PVD), or thick-film printing. For example, the electron emitting layers 205 may be formed by thick-film printing a carbon-based paste followed by a patterning process by drying, exposure, and development.

In the exemplary embodiment illustrated in FIGS. 1 and 2, when voltages are alternately applied to the first electrodes 203 and the second electrodes 204, the first electrodes 203 and the second electrodes 204 may function alternately. Electrons may first be emitted from electron emitting layers 205a, covering the first electrodes 203, to the second electrodes 204, and then electrons may be emitted from electron emitting layers 205b, covering the second electrodes 204, to the first electrodes 203. Such alternating voltage application or multi-direction electron emission process may ensure more stable electron emission, as compared to devices that operate with unidirectional electron emission.

In embodiments of the invention employing such a multi-directional electron emission process, an amount of time taken to apply a predetermined driving voltage to either the first electrodes 203 or the second electrodes 203 and 204 may be reduced. For example, in embodiments of the invention that alternately drive the first electrodes 203 and the second electrodes 204, an amount of time taken for applying a predetermined driving voltage may reduced to about a half of the time taken to apply a driving voltage in unidirectional electron emission structure. Thus, a life-span of the electron emitting layers 205 may be extended and electron emission stability may be improved.

In embodiments of the invention employing such multi-directional electron emission may be advantageous over unidirectional electron emission structures at least because electrons may be prevented from being emitted from a section to which no driving voltage is supplied, thereby preventing the degradation of the fluorescent layer 208 due to electron sputtering and significantly extending the life of the fluorescent layer 208.

In embodiments of the invention, the electron emitting layers 205 may cover only one of the first electrodes 203 or the second electrodes 204. In embodiments of the invention, the electron emitting layers 205 may only be provided on electrodes that contribute to electron emission. For example, as shown in FIG. 1, in embodiments of the invention, the electron emitting layers 205 may not be provided on a left surface of a leftmost electrode, which may be, e.g., one of the first electrodes 203 or one of the second electrodes 204. In embodiments of the invention, the electron emitting layers 205 may not be provided on a right surface of a rightmost electrode, which may be, e.g., one of the first electrodes 203 or one of the second electrodes 204.

The electron emitting layers 205 may be separated by a predetermined distance l₂₀₀ from a stack of the anode 207 and the fluorescent layer 208 so that electrons can be accelerated by an anode field and may collide with the fluorescent layer 208 at a sufficient speed to emit visible light.

The rear substrate 202 and the front substrate 201, on which the anode 207 and the fluorescent layer 208 may be formed, may be arranged to face each other and may be sealed using a sealant such as a sealing glass frit to form the sealed part 206.

A sealing glass frit may be coated, while in a mushy state, along an edge of the rear substrate 202 using, e.g., dispensing, screen printing, or a similar coating processes. The sealing glass frit material may then be dried to remove, e.g., water in the sealing glass frit. The rear substrate 202 and the front substrate 201 may then be aligned and the sealing glass frit may be sintered at high temperature to completely seal the rear substrate 202 and the front substrate 201. The inner space 210 between the front substrate 201 and the rear substrate 202 may then be subjected to a high vacuum using an exhaust port (not shown) or the like in order to create a vacuumed environment within the inner space 210.

Exemplary operation of a backlight unit 200 having the above electrode structure will be explained. As discussed above, in embodiments of the invention, predetermined voltages may be alternately applied to the first electrodes 203 and the second electrodes 204 to generate electrons to be emitted from the first electrodes 203 through the electron emitting layers 205a to respective opposite facing surfaces of the second electrodes 204 and/or to generate electrons to be emitted from the second electrodes 204 through the electron emitting layers 205b to respective opposite facing surfaces of the first electrodes 203.

Electrons may then be accelerated by an electric field to make the electrons collide with the fluorescent layer 208. The electric field may be generated by the anode 207 that may be disposed on the front substrate 201. From the excited energy state, resulting from electron collisions, the fluorescent substrate 201 may emit visible light while returning to its ground energy state, and the visible light may be emitted externally through the front substrate 201.

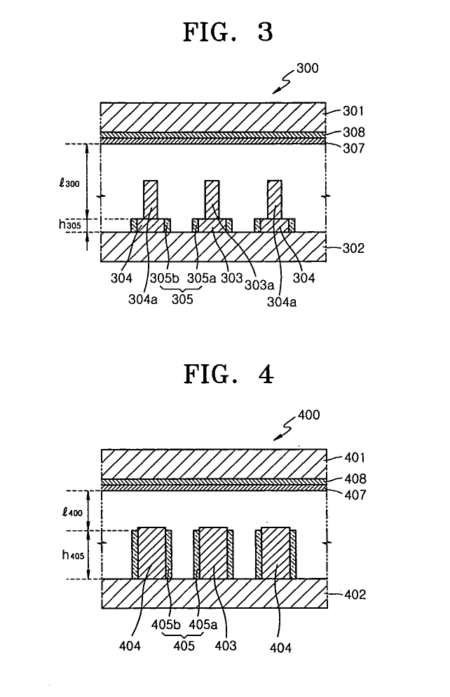

FIG. 3 illustrates a partial, enlarged cross-sectional view of an electron emission type backlight unit according to another embodiment of the invention. For simplicity, only differences between the exemplary embodiment illustrated in FIG. 3 and the exemplary embodiment illustrated in FIGS. 1 and 2 will be described below.

Similarly to the exemplary embodiments of the backlight unit 200 shown in FIGS. 1 and 2, a backlight unit 300 according to the second exemplary embodiment may include a front substrate 301, a fluorescent layer 308, an anode 307, a rear substrate 302, first electrodes 303, second electrodes 304, and electron emitting layers 305. As discussed above, the electron emitting layers 305 may include electron emitting layers 305a and 305b, which may be respectively associated with the first electrodes 303 and the second electrodes 304.

In the exemplary embodiment of the backlight unit 300 illustrated in FIG. 3 auxiliary electrodes may be disposed on at least one of the first electrodes 303 and the second electrodes 304. Auxiliary electrodes 303a may be disposed on the first electrodes 303 and auxiliary electrodes 304a may be disposed on the second electrodes 304. The auxiliary electrodes 303a, 304a may be formed, e.g., of the same materials as the first electrodes 303 and the second electrodes 304, respectively. In embodiments of the invention, different materials may be used to form the auxiliary electrodes 303a, 304a, the first electrodes 303 and the second electrodes 304.

An anode electric field may be reduced further due to the auxiliary electrodes 303a and 304a, thereby strengthening and stabilizing an electric field generated between the first electrodes 303 and the second electrodes 304. By strengthening and stabilizing the electric field generated between the first electrodes 303 and the second electrodes 304, electron emission efficiency and stability may be improved.

As shown in FIG. 3, a height h₃₀₅ of the electron emitting layers 305 and the first and second electrodes 303 and 304 may be equal to or substantially equal to the height h₂₀₅ of the electron emitting layers 205, according to the exemplary embodiments shown in FIGS. 1 and 2. In embodiments of the invention including the auxiliary electrodes 303a and/or 304a, the anode field effect may be blocked or limited according to a height of the auxiliary electrodes 303a and 304a.

The electron emitting layers 305 covering the first electrodes 303 and/or the second electrodes 304 may be separated by a predetermined distance l₃₀₀ from a stack of the anode 307 and the fluorescent layer 308 so that electrons can be accelerated by the anode field and may collide with the fluorescent layer 308 at a sufficient speed to emit visible light.

FIG. 4 illustrates a partial, enlarged cross-sectional view of an electron emission type backlight unit according to another embodiment of the invention. For simplicity, only differences between the exemplary embodiment illustrated in FIG. 4 and the exemplary embodiments illustrated in FIGS. 1-2 will be described below.

Similarly to the exemplary embodiments of the backlight unit 200 shown in FIGS. 1 and 2, a backlight unit 400 may include a front substrate 401, a fluorescent layer 408, an anode 407, a rear substrate 402, first electrodes 403, second electrodes 404, and electron emitting layers 405. As discussed above, the electron emitting layers 405 may include electron emitting layers 405a and 405b, which may be respectively associated with the first electrodes 403 and the second electrodes 404.

In the exemplary embodiment of the backlight unit 400 illustrated in FIG. 4, the electron emitting layers 405 may have a height h₄₀₅ that is less than a height of the first electrodes 403 and the second electrodes 404 relative to a flat surface of the rear substrate 402 that faces the front substrate 401.

In embodiments of the invention in which the height h₄₀₅ Of the electron emitting layers 405a, 405b may be less than the height of the first electrodes 403 and the second electrodes 404 relative to a flat surface of the rear substrate 402 that faces the front substrate 401, the height h₄₀₅ of the electron emitting layers 405 may be greater than the height h₂₀₅ of the electron emitting layers 205, according to the exemplary embodiments shown in FIGS. 1 and 2. Thus, in exemplary embodiments of the invention, the first electrodes 403 and the second electrodes 404 may extend further from the flat surface of the rear substrate 402 toward the front substrate 401, and may be closer to the first substrate 401 than the first electrodes 203 and the second electrodes 204 of exemplary embodiments described with relation to FIGS. 1 and 2.

By increasing the height of the first electrodes 403 and the second electrodes 404 relative to the rear substrate 402, the first and second electrodes 403 and 404 may further reduce an anode field generated by the anode 407, thereby improving efficiency in controlling electron emission from the first electrodes 403 and/or the second electrodes 404.

In embodiments of the invention, a distance l₄₀₀ between the electron emitting layers 405 and the stack of the anode 407 and the fluorescent layer 408 may be reduced, and thus an area of the electron emitting layers 405 which actually contribute to visible light emission can be increased. In embodiments of the invention, by increasing the heights of the first electrodes 403 and the second electrodes 404 relative to a flat surface of the rear substrate 402 that faces the front substrate 401, cross-sectional areas of the first and second electrodes 403 and 404 increase, thereby reducing resistance and reducing and/or preventing a voltage drop in a direction perpendicular to the direction that the first electrodes 403 and the second electrodes 404 extend away from a flat surface of the rear substrate 402 facing the front substrate 401.

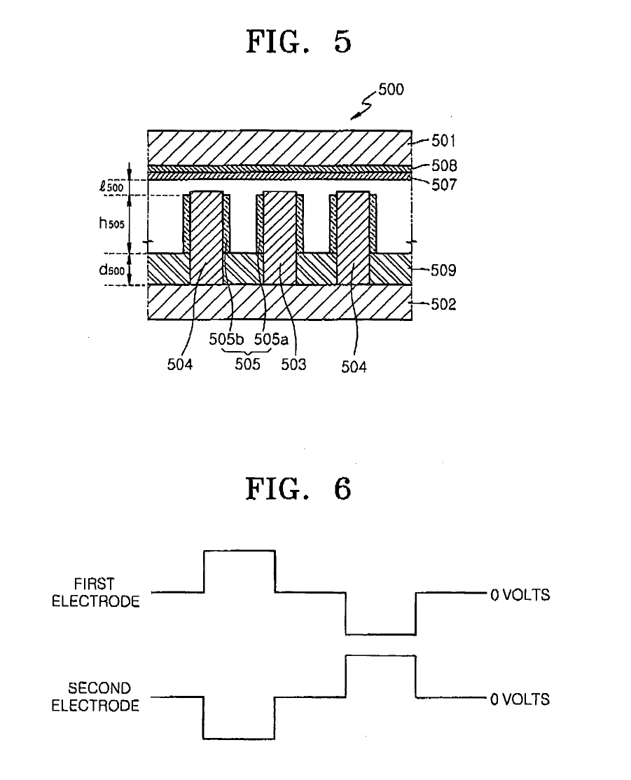

FIG. 5 illustrates a partial, enlarged cross-sectional view of an electron emission type backlight unit according to another embodiment of the invention. For simplicity, only differences between the exemplary embodiment illustrated in FIG. 5 and the exemplary embodiments illustrated in FIGS. 1-2 will be described below.

Similarly to the exemplary embodiments of the backlight unit 200 shown in FIGS. 1 and 2, a backlight unit 500 may include a front substrate 501, a fluorescent layer 508, an anode 507, a rear substrate 502, first electrodes 503, second electrodes 504, and electron emitting layers 505. As discussed above, the electron emitting layers 505 may include electron emitting layers 505a and 505b, which may be respectively associated with the first electrodes 503 and the second electrodes 504.

In the exemplary embodiment of the backlight unit 400 illustrated in FIG. 5, the electron emitting layers 505 may be separated by a predetermined distance d₅₀₀ from a flat surface of the rear substrate 502 that faces the front surface 501. The electron emitting layers 505 may only be formed along a portion of the opposite facing surfaces of the first electrodes 503 and the second electrodes 504, and may not extend to one or both end portions of the opposite facing surfaces of the first electrodes 503 and the second electrodes 504.

For example, the electron emitting layers 505 may be separated by the predetermined distance d₅₀₀ from the flat surface of the rear substrate 502 that faces the front surface 501, and the first electrodes 503 and/or the second electrodes 504 may extend further away from the flat surface of the rear substrate 502 that the electron emitting layers 505.

In such embodiments of the invention, the height h₅₀₅ of the electron emitting layers 505 may equal to or greater than the height h₂₀₅ of the exemplary embodiment of the electron emitting layers 205, shown in FIGS. 1 and 2. In such embodiments of the invention, the first electrodes 503 and the second electrodes 504 may be formed to have a height greater than the sum of the distance d₅₀₀ and the height h₅₀₅ of the electron emitting layers 505 to achieve desired electron emission.

That is, because the electron emitting layers 505 may be separated by the distance d₅₀₀ from the flat surface of the rear substrate 502 that faces the front substrate 501, a distance l₅₀₀ between the electron emitting layers 505 and a stack of the anode 507 and the fluorescent layer 508 may be reduced relative to, e.g., the exemplary embodiment shown in FIGS. 1 and 2. Thus, the area of the electron emitting layers 505, which actually contributes to visible light emission may be increased. As the first electrodes 503 and the second electrodes 504 may have the greatest heights, relative to the electron emission layers 505, cross-sectional areas of the first and second electrodes 503 and 504 may increase, preventing a voltage drop in a direction perpendicular to the direction that the first electrodes 503 and the second electrodes 504 extend away from a flat surface of the rear substrate 502 facing the front substrate 501.

In embodiments of the invention in which the electron emitting layers 505 do not to reach the end portions of at least one of the first and second electrodes 503 and 504 closest to the front substrate 501, the first and second electrodes 503 and 504 may further reduce an anode field generated by the anode 507, thereby improving the efficiency of controlling electron emission from the second electrodes 504. Embodiments of the present invention are not limited thereto. For example, the electron emitting layers 505 may reach the end portions of at least one of the first electrodes 503 and the second electrodes 504 closest to the front substrate 501.

As shown in FIG. 5, intermediate layers 509 may be formed between the rear substrate 502 and the electron emitting layers 505, and on portions between the first electrodes 503 and the second electrodes 504 wherein the electron emitting layers 505 are not disposed. As shown in the exemplary embodiment illustrated in FIG. 5, the intermediate layers 509 may not be provided at the end portion of the first electrodes 503 and/or the second electrodes 505 closest to the anode 507, even in embodiments when the electron emitting layers 505 do not extend to the end portion of the first electrodes 503 and/or the second electrode 504 closest to the anode 507.

To fabricate the exemplary embodiment shown in FIG. 5, the intermediate layers 509 may be formed on the rear substrate 502. Then, the electron emitting layers 505 may be formed on the intermediate layers 509, which is easier than directly forming the electron emitting layers 505 on side surfaces of the first electrodes 503 and/or the second electrodes 504 without the intermediate layers 509.

In embodiments of the invention, the intermediate layers 509 may be formed of an insulating material. In embodiments of the invention, the intermediate layers 509 may be removed after formation of the electron emitting layers 505. In embodiments of the invention, a strong electric field may be formed around the electron emitting layers 505 between the first electrodes 503 and the second electrodes 504, thereby enabling more stable electron emission.

An exemplary method of driving a backlight unit, e.g., any one of the exemplary backlight units shown in FIGS. 1 through 5, to reduce power consumption and extend the life of the electron emitting layers will be explained with reference to FIG. 6.

When electron emitting layers cover both first electrodes and second electrodes, a positive (+) voltage may be applied to any one of the two electrodes and a negative (−) voltage may be applied to the rest. In this structure, positive (+) and negative (−) voltages may be alternately applied to the first electrodes and the second electrodes, as shown in FIG. 6, so that the electron emitting layers covering the adjacent electrodes alternately emit electrons. Accordingly, the life span of the electron emitting layers can be at least twice as long as when only specific electrodes are used as cathode electrodes.

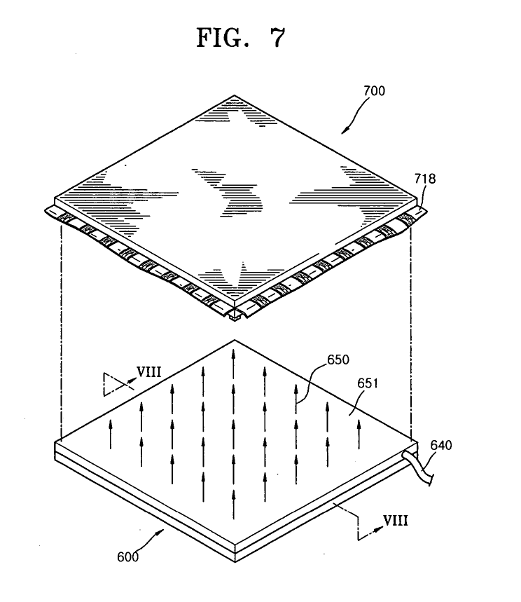

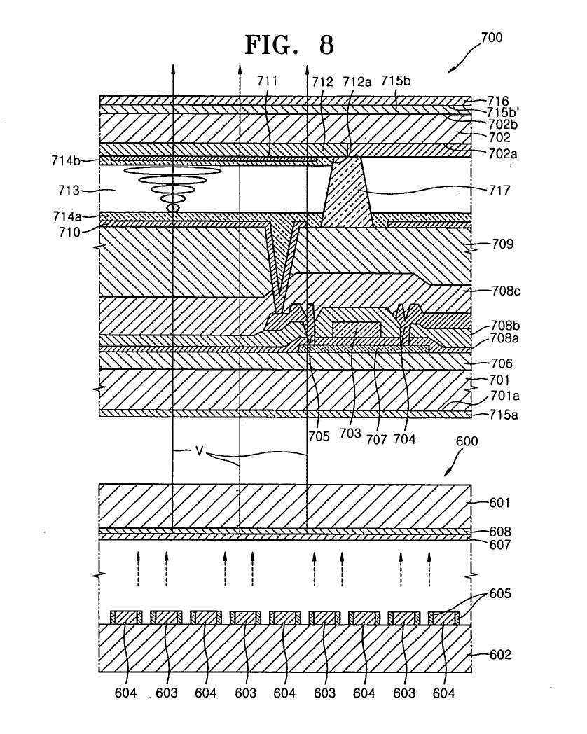

FIG. 7 illustrates an exploded perspective view of a liquid crystal display (LCD) device and a backlight unit according to an exemplary embodiment of the present invention. More particularly, FIG. 7 illustrates an LCD device 700 and an electron emission type backlight unit 600 for providing light to the LCD device 700. FIG. 8 illustrates a partial cross-sectional view of the LCD and the backlight unit shown in FIG. 7, along line VIII-VIII of FIG. 7. The backlight unit 600 of FIG. 8 may be any one of the backlight units illustrated in FIGS. 1 through 5.

As shown in FIG. 7, a flexible printed circuit board (PCB) 718 for transmitting an image signal may be attached to the LCD device 700. The backlight unit 600 may be disposed behind the LCD device 700.

The backlight unit 600, which may be an electron emission type backlight unit, may receive power through a connecting cable 640, and may emit visible light 650 through a front surface 651 of the backlight unit 600 to the LCD device 700.

In the following description, the electron emission type backlight unit 200 of FIGS. 1 and 2 will be used as an example.

The LCD device 700 may include a first substrate 701. A buffer layer 706 may be formed on the first substrate 701. A semiconductor layer 707 may be formed in a predetermined pattern on the buffer layer 706. A first insulting layer 708a may be formed on the semiconductor layer 707. A second electrode 703 may be formed in a predetermined pattern on the first insulating layer 708a. A second insulating layer 708b may be formed on the second electrode 703. The first insulating layer 708a and the second insulating layer 708b may then be etched by dry etching to expose a part of the semiconductor layer 707, and a source electrode 704 and a drain electrode 705 may be formed in a predetermined region including the exposed part of the semiconductor layer 707. Next, a third insulating layer 708c may be formed, and a planarization layer 709 may be formed on the third insulating layer 708c. A first electrode 710 may be formed in a predetermined pattern on the planarization layer 709. The third insulating layer 708c and the planarization layer 709 are partially etched to form a conductive path between the drain electrode 705 and the first electrode 710.

A transparent second substrate 702 may be separately manufactured from the first substrate 701, and a color filter layer 712 may be formed on a bottom surface 702a of the second substrate 702. A second electrode 711 may be formed on a bottom surface 712a of the color filter layer 712, and a first alignment layer 714a and a second alignment layer 714b facing a liquid crystal layer 713 may be formed on opposing surfaces of the first electrode 710 and the second electrode 711. A first polarization layer 715a may be formed on a bottom surface 701a of the first substrate 701, and a second polarization layer 715b may be formed on a top surface 702b of the second substrate 702. A protective film 716 may be formed on a top surface 715b′ of the second polarization layer 715b. A spacer 717 partitioning the liquid crystal layer 713 may be formed between the color filter layer 712 and the planarization layer 709.

The operation of the backlight unit 600 and the LCD device 700 will now be briefly described. When an external power is applied to the backlight unit 200, an electric field may be formed between first electrodes 603 and second electrodes 604. Electrons may be supplied by the first electrodes 603, and may be emitted through electron emitting layers 605 to collide with a fluorescent layer 608 due to an anode 607 disposed on a front substrate 601. The collision of electrons with the fluorescent layer 608 may generate and emit visible light V to the LCD device 700.

In the LCD device 700, a potential difference may exist between the first electrode 710 and the second electrode 711 due to an external signal controlled by the second electrode 703, the source electrode 704, and the drain electrode 705. Alignment of the liquid crystal layer 713 may be determined by the potential difference. Visible light V provided by the backlight unit 600 may be blocked or transmitted according to the alignment of the liquid crystal layer 713. The transmitted visible light V may pass through the color filter layer 712 and may radiate color, thereby realizing an image.

While the LCD device 700 in FIG. 8 may be a thin film transistor-liquid crystal display (TFT-LCD), the LCD device 700 is not limited thereto, and may be various non-emissive display panels.

The LCD device 700 employing the electron emission type backlight unit 600 may have improved image brightness, an extended life span, and may consume less power, as the brightness and life-span of the backlight unit 600 increases.

In embodiments of the invention, structures of first electrodes, second electrodes, and electron emitting layers enable a reduction in an anode field, thereby improving efficiency in electron emission from the first electrodes and/or the second electrodes.

In embodiments of the invention, first electrodes and second electrodes may be alternately arranged, and voltages may be alternately applied to the first electrodes and the second electrodes, thus unnecessary electron emission may be reduced to decrease power consumption and to extend a life-time of the fluorescent layer by reducing the deterioration of the fluorescent layer.

In embodiments of the invention, electron emitting layers may only be provided at portions of electrodes, e.g., first and/or second electrodes, which do not contribute to electron emission, and thus, costs incurred due to the electron emitting layers can be reduced.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An electron emission type backlight unit, comprising:
a front substrate;
a rear substrate facing the front substrate with a predetermined distance therebetween;
an anode and a fluorescent layer disposed behind the front substrate;
first electrodes and second electrodes disposed on the rear substrate, the first electrodes and the second electrodes being spaced apart from each other; and
electron emitting layers at least partially covering sides of at least one of the first electrodes and the second electrodes that extend along a direction other than a direction substantially or exactly parallel to the front substrate.

2. The electron emission type backlight unit as claimed in claim 1, wherein the first electrodes and the second electrodes, which are covered by the electron emitting layers, have substantially a same shape.

3. The electron emission type backlight unit as claimed in claim 1, wherein the first electrodes and the second electrodes are alternately arranged in parallel on a top surface of the rear substrate facing the front substrate.

4. The electron emission type backlight unit as claimed in claim 1, wherein the first electrodes and the second electrodes form a striped pattern.

5. The electron emission type backlight unit as claimed in claim 1, wherein the first electrodes and the second electrodes have a same or substantially same height as measured from a flat surface of the rear substrate.

6. The electron emission type backlight unit as claimed in claim 1, wherein the electron emitting layers cover opposing side surfaces of at least one of the first electrodes and the second electrodes.

7. The electron emission type backlight unit as claimed in claim 6, wherein the electron emitting layers have a same or substantially same height as the electrodes covered by the electron emitting layers as measured from a flat surface of the rear substrate.

8. The electron emission type backlight unit as claimed in claim 1, further comprising auxiliary electrodes disposed on at least one of the first electrodes and the second electrodes to limit an anode field effect.

9. The electron emission type backlight unit as claimed in claim 1, wherein an end portion of the respective one of the electron emitting layers closer to the front substrate is further from the front substrate than an end portion of the electrode covered by the respective electron emitting layer to limit an anode field effect.

10. The electron emission type backlight unit as claimed in claim 6, wherein the electron emitting layers are spaced apart from a flat surface of the rear substrate facing the front substrate by a predetermined distance.

11. The electron emission type backlight unit as claimed in claim 10, further comprising insulating layers disposed between the rear substrate and the electron emitting layers, covering portions of the first electrodes and the second electrodes extending along the predetermined distance defined by the space between the flat surface of the rear substrate and the respective one of the electron emitting layers.

12. The electron emission type backlight unit as claimed in claim 1, wherein the electron emitting layers include a carbon nanotube.

13. A flat panel display device, comprising:
an electron emission type backlight unit including
a front substrate and a rear substrate facing each other with a predetermined distance therebetween,
an anode and a fluorescent layer disposed between the front substrate and the rear substrate,
first electrodes and second electrodes disposed between the front substrate and the rear substrate to be spaced apart from each other, and
electron emitting layers at least partially covering sides of at least one of the first electrodes and the second electrodes that extend along a direction other than a direction substantially or exactly parallel to the front substrate; and
a light receiving device that is disposed in front of the electron emission type backlight unit and controls light provided by the electron emission type backlight unit to produce an image.

14. The flat panel display device as claimed in claim 13, wherein the anode and the fluorescent layer are sequentially stacked on a bottom surface of the front substrate facing the rear substrate.

15. The flat panel display device as claimed in claim 13, wherein the electron emitting layers have a same or substantially same height as the electrodes covered by the electron emitting layers as measured from a flat surface of the rear substrate.

16. The flat panel display device as claimed in claim 13, further comprising auxiliary electrodes disposed on at least one of the first electrodes and the second electrodes to block an anode field.

17. The flat panel display device as claimed in claim 13, wherein the electron emitting layers extend a shorter distance from a flat surface of the rear substrate than the electrodes covered by the electron emitting layers, thereby reducing an anode field effect.

18. The flat panel display device as claimed in claim 13, wherein the light receiving device is a liquid crystal display device.

19. A method of driving a flat panel display device, the flat panel display device including:
an electron emission type backlight unit having
a front substrate and a rear substrate facing each other with a predetermined distance therebetween,
an anode and a fluorescent layer disposed between the front substrate and the rear substrate,
first electrodes and second electrodes disposed between the front substrate and the rear substrate to be spaced apart from each other, and
electron emitting layers covering opposing surfaces between the first electrodes and the second electrodes; and
a light receiving device that is disposed in front of the electron emission type backlight unit and controls light provided by the electron emission type backlight unit in order to produce an image, the method comprising:
repeatedly applying a higher voltage to the first electrodes and a lower voltage to the second electrodes for a first period of time and, alternately, applying a lower voltage to the first electrodes and a higher voltage to the second electrodes for a second period of time such that electrons are alternately emitted from the electron emitting layers covering the first electrodes and the electron emitting layers covering the second electrodes.

20. The method as claimed in claim 19, wherein a voltage higher than the voltages applied to the first electrodes and the second electrodes is applied to the anode.
